(19) United States
(12) Patent Application Publication
(10) Pub. No.: US 2007/0068422 A1
(43) Pub. Date: Mar. 29, 2007

(54) MODIFIED SULPHUR AND PRODUCT COMPRISING MODIFIED SULPHUR AS BINDER

(76) Inventors: Marinus Johannes REYNHOUT, Amsterdam (NL); Rob Aloysius Maria Van Trier, Eindhoven (NL); Guy Lode Magda Maria Verbist, Amsterdam (NL)

Correspondence Address: SHELL OIL COMPANY, P O BOX 2463, HOUSTON, TX, 772522463, US

(21) Appl. No.: 11/424,287

(22) Filed: Jun. 15, 2006

(30) Foreign Application Priority Data
Jun. 17, 2005 (EP) 05105376.7

(51) Int. Cl. C04B 28/36

(52) U.S. Cl. 106/287.32

(57) ABSTRACT

The invention provides modified sulphur prepared by admixing molten elemental sulphur with one or more olefinic sulphur modifiers, wherein at least 50 wt % of the olefinic sulphur modifiers is 5-ethylidene-2-norbornene and/or 5-vinyl-2-norbornene and wherein the total amount of olefinic sulphur modifiers is in the range of from 0.1 to 20 wt % based on the weight of sulphur. The invention further provides a product comprising such modified sulphur as binder which is prepared by admixing such modified sulphur, a filler and/or aggregate, and optionally elemental sulphur at a temperature above the melting temperature of sulphur and solidifying the mixture obtained by cooling the mixture to a temperature below the melting temperature of sulphur.

### CROSS-REFERENCE TO RELATED APPLICATIONS

This application claims priority from European Patent Application No. 05105376.7 filed on Jun. 17, 2005, which is incorporated herein by reference.

### FIELD OF THE INVENTION

The invention provides modified sulphur and a product comprising modified sulphur as binder prepared by admixing such modified sulphur, a filler and/or aggregate, and optionally elemental sulphur at a temperature above the melting temperature of sulphur and solidifying the mixture obtained by cooling the mixture to a temperature below the melting temperature of sulphur.

### BACKGROUND OF THE INVENTION

Conventional construction materials such as mortar or concrete based on Portland cement have a good durability under alkaline conditions. Their acid resistance is, however, poor. Under acidic conditions, construction materials with sulphur as binder may be used, since these materials show a very good stability under acidic conditions. The alkaline resistance of sulphur-bound products is, however, poor, especially if compared with Portland cement products.

In sulphur-bound materials such as sulphur cement or sulphur cement-aggregate composites, elemental sulphur is used as binder. The sulphur used in such products is typically modified or plasticised in order to prevent allotropic transformation of the solid sulphur. Modified sulphur is typically prepared by reacting a portion of the sulphur with a sulphur modifier, also referred to as sulphur plasticiser. A well-known category of sulphur modifiers, are olefinic compounds that co-polymerise with sulphur. Known examples of such olefinic sulphur modifiers are dicyclopentadiene, limonene, styrene or naphthalene. Reference is for example made to B. R. Currell et al. “Plasticization of Sulfur” In: J. R. West (ed.), Proceedings of symposium “New Uses of Sulfur”, Los Angeles, April 1974, Advances in Chemistry Series No. 140, Am. Chem. Soc., Washington, 1975, p. 1-17.

Plasticised or modified sulphur may be used in the form of a so-called concentrate, i.e. sulphur reacted with a relatively high amount of modifier. For the preparation of the sulphur-bound product, e.g. concrete, the concentrate is then mixed at a temperature above the melting temperature of sulphur with further sulphur, filler and aggregate, and solidified.

### SUMMARY OF THE INVENTION

It has now been found that cement or cement-based constructions materials that show a good durability under both acidic and alkaline conditions can be obtained if sulphur modified with 5-ethylidene-2-norbornene or 5-vinyl-2-norbornene in specific amounts is used as binder.

The use of ethylidene norbornene or 5-vinyl norbornene as sulphur modifier is known. In Research Disclosure no. 22924, 1983, it is mentioned that ethylidene norbornene or 5-vinyl norbornene may be used as sulphur plasticiser. In the examples, plasticised sulphur is prepared by reacting elemental sulphur with 40-43 wt % olefinic plasticisers (as a blend including ethylidene norbornene and 5-vinyl norbornene) based on the weight of sulphur. The resulting plasticised sulphur is a black glassy solid and thus not suitable to be further processed into sulphur-bound products such as cement, mortar or concrete.

It has now been found that if the olefinic modifiers used comprise at least 50 wt % 5-ethylidene-2-norbornene or 5-vinyl-2-norbornene and the total concentration of olefinic modifier does not exceed 20 wt % of the weight of sulphur at any stage of the modified sulphur preparation process, a modified sulphur is obtained that, if used in sulphur-bound products, results in sulphur-bound products that are both acid and alkaline resistant. Accordingly, the present invention relates to modified sulphur prepared by admixing molten elemental sulphur with one or more olefinic sulphur modifiers, wherein at least 50 wt % of the olefinic sulphur modifiers is 5-ethylidene-2-norbornene and/or 5-vinyl-2-norbornene and wherein the total amount of olefinic sulphur modifiers is in the range of from 0.1 to 20 wt % based on the weight of sulphur.

An advantage of the modified sulphur according to the invention is its high alkaline resistance. Both the modified sulphur itself and the sulphur-bound products prepared with it have a surprisingly high alkaline resistance.

Other advantages of the modified sulphur according to the invention compared to modified sulphur prepared with the most common sulphur modifier, i.e. dicyclopentadiene, are the lower toxicity and the higher stability of 5-ethylidene-2-norbornene and 5-vinyl-2-norbornene. As a result, processing of 5-ethylidene-2-norbornene and/or 5-vinyl-2-norbornene into modified sulphur is less complicated than processing of dicyclopentadiene.

A further advantage of the modified sulphur according to the invention is that it has a light colour. As a result, the sulphur-bound products in which the modified sulphur of the present invention is used are light in colour and can be pigmented in the desired colour.

In a further aspect, the invention relates to a product comprising modified sulphur as binder which is prepared by admixing a modified sulphur as hereinbefore defined, a filler and/or aggregate, and optionally elemental sulphur at a temperature above the melting temperature of sulphur and solidifying the mixture obtained by cooling the mixture to a temperature below the melting temperature of sulphur.

### DETAILED DESCRIPTION OF THE INVENTION

The modified sulphur according to the present invention is prepared by admixing molten elemental sulphur with one or more olefinic sulphur modifiers. At least 50 wt % of the olefinic sulphur modifiers admixed with the elemental sulphur is 5-ethylidene-2-norbornene and/or 5-vinyl-2-norbornene.

Preparation of modified sulphur is known in the art. Molten elemental sulphur and one or more modifiers are admixed at a temperature above the melting temperature of sulphur, i.e. above 120° C., and below the boiling temperature of the modifier to let part of the sulphur react with the modifiers. Typically, the temperature is in the range of from 120 to 150° C. The modified sulphur according to the present invention may be prepared by admixing the sulphur and the modifiers at any suitable temperature, preferably at a temperature in the range of from 120 to 150° C. more preferably of from 130 to 140° C.

The elemental sulphur that is admixed with the modifiers in the preparation of the modified sulphur according to the invention may be obtained from any source. Typically, the elemental sulphur will be elemental sulphur obtained as by-product from the desulphurisation of crude oil, natural gas or ores. The elemental sulphur may comprise small amounts of contaminants typically in a concentration ranging from a few milligrams to a few grams per kilogram, for example mercaptans.

The total amount of olefinic sulphur modifiers admixed with the sulphur in the modified sulphur preparation process is in the range of from 0.1 to 20 wt % based on the weight of sulphur. A smaller amount, i.e. less than 0.1 wt %, would not provide for the desired modification effect, i.e. prevention of the allotropic transformation of the solid sulphur. A higher amount of olefinic sulphur modifiers, i.e. above 20 wt %, would result in a modified sulphur with undesirable mechanical properties and of an undesirable dark colour. Moreover, the thus-obtained modified sulphur is not soluble anymore in further molten elemental sulphur and can thus not be used as modified sulphur concentrate.

An advantage of the use of 5-ethylidene-2-norbornene and/or 5-vinyl-2-norbornene as modifier instead of the most common olefinic modifier, i.e. dicyclopentadiene, is that it is easier to process. The dicyclopentadiene dimer reverts to its volatile monomer during processing and therefore has to be reacted with sulphur under refluxing conditions. The reaction of 5-ethylidene-2-norbornene or 5-vinyl-2-norbornene with sulphur can take place at a temperature below its boiling temperature and, thus, the modified sulphur preparation can be carried out without refluxing of the modifier. Another advantage is that the toxicity of 5-ethylidene-2-norbornene and 5-vinyl-2-norbornene is much lower than that of dicyclopentadiene.

It is preferred that at least 80 wt % of the olefinic modifiers admixed with the molten sulphur is 5-ethylidene-2-norbornene and/or 5-vinyl-2-norbornene, more preferably no other olefinic modifiers than 5-ethylidene-2-norbornene and/or 5-vinyl-2-norbornene are used in the preparation of the modified sulphur according to the invention. Even more preferably, 5-ethylidene-2-norbornene is the only modifier used.

The modified sulphur according to the invention is particularly suitable to be used in products comprising modified sulphur as a binder. Examples of such sulphur-bound products are sulphur cement and sulphur cement-aggregate composites such as sulphur mortar, sulphur concrete or sulphur-extended asphalt.

Sulphur cement is known in the art and typically comprises modified sulphur, usually in an amount of at least 50 wt %, and a filler. Usual sulphur cement fillers are particulate inorganic material with an average particle size in the range of from 0.1 μm to 0.1 mm. Examples of such sulphur cement fillers are fly ash, limestone, quartz, iron oxide, alumina, titania, graphite, gypsum, talc, mica or combinations thereof. The filler content of sulphur cement may vary widely, but is typically in the range of from 5 to 50 wt %, based on the total weight of the cement.

Reference herein to sulphur cement-aggregate composites is to a composite comprising both sulphur cement and aggregate. Examples of sulphur cement-aggregate composites are sulphur mortar, sulphur concrete and sulphur-extended asphalt. Mortar comprises fine aggregate, typically with particles having an average diameter between 0.1 and 5 mm, for example sand. Concrete comprises coarse aggregate, typically with particles having an average diameter between 5 and 40 mm, for example gravel or rock. Sulphur-extended asphalt is asphalt, i.e. typically aggregate with a binder that contains filler and a residual hydrocarbon fraction, wherein part of the binder has been replaced by sulphur, usually modified sulphur.

The sulphur-bound products according to the invention are prepared by admixing modified sulphur according to the invention with a filler and/or aggregate and optionally further elemental sulphur. It will be appreciated that it depends on the desired product and on the amount of modifier-sulphur reaction product in the modified sulphur what components in what amounts will be admixed.

Preferably, the amount of olefinic modifier used in the preparation of the modified sulphur used does not exceed 5 wt % of the weight of sulphur in the final product, i.e. the sulphur-bound product. Reference herein to the weight of sulphur in the sulphur-bound product is to the total amount of sulphur used, i.e. the amount of sulphur mixed with the modifier(s) in the modified sulphur preparation and the amount of sulphur that is optionally admixed with the modified sulphur and the filler/aggregate in the product preparation.

It has been found that the use of an amount of olefinic modifiers below 5 wt % of the amount of sulphur in the final product, results in a stable product with good mechanical properties that is durable if exposed to alkaline or acidic conditions. An advantage of using a relatively low amount of olefinic modifiers is that the time needed for solidification is minimised. Preferably, the amount of olefinic modifiers used is in the range of from 0.1 to 4.0 wt % of the total weight of sulphur in the product, more preferably 0.1 to 3.0 wt %.

Preferably, a so-called modified sulphur concentrate is used in the preparation of the sulphur-bound product according to the invention, i.e. a modified sulphur that has been prepared with an amount of modifier that is higher than that desired in the sulphur-bound product. In that case, modified sulphur and elemental sulphur are admixed with filler and/or aggregate in the preparation of the sulphur-bound product. An advantage of starting with a modified sulphur concentrate is that transportation costs are limited if the modified sulphur is manufactured at a different place than the sulphur-bound product.

Preferably, a modified sulphur concentrate prepared by admixing sulphur with 5 to 15 wt % olefinic modifier is used, more preferably 7 to 12 wt %, based on the weight of sulphur.

Alternatively, a modified sulphur already comprising all the sulphur present in the resulting sulphur-bound product may be used. In that case, a modified sulphur prepared by admixing sulphur with 0.1 to 5.0 wt % olefinic modifier is preferably used, more preferably with 0.1 to 4.0 wt % olefinic modifier, even preferably with 0.1 to 3.0 wt % olefinic modifier.

It is preferred that the modified sulphur used for the preparation of the sulphur-bound product has been modified with no other olefinic modifiers than 5-ethylidene-2-norbornene and/or 5-vinyl-2-norbornene. If the modified sulphur, however, has been modified with a mixture of 5-ethylidene-2-norbornene or 5-vinyl-2-norbornene and other olefinic modifiers, it is preferred that the amount of other modifiers is at most 1 wt % of the total weight of sulphur in the sulphur-bound product.

If one or more olefinic modifiers other than 5-ethylidene-2-norbornene or 5-vinyl-2-norbornene are used in the preparation of the modified sulphur according to the invention, it may be any olefinic sulphur modifier known in the art, for example dicyclopentadiene, cyclopentadiene, styrene, dipentene, oligomers of dicyclopentadiene or combinations of two or more thereof.

### EXAMPLES

The invention is further illustrated by means of the following non-limiting examples.

### Example 1

The alkaline resistance of unmodified sulphur and modified sulphur was determined.

Preparation of Modified Sulphur

A first modified sulphur (sample 1; according to the invention) was prepared as follows. An amount of elemental sulphur was weighted in a glass tube. The sulphur was melted by placing the tube in an oil bath of 135° C. An amount of 5-ethylidene-2-norbornene (5 wt % based on the weight of sulphur) was added and the fluid was stirred for 3 hours. The tube was then taken out of the oil bath and the fluid was poured in a cylindrical mould and allowed to solidify at room temperature.

A second modified sulphur (sample 2; according to the invention) was prepared as follows. An amount of elemental sulphur was weighted in a glass tube. The sulphur was melted by placing the tube in an oil bath of 150° C. An amount of 5-ethylidene-2-norbornene (10 wt % based on the weight of sulphur) was added and the fluid was stirred for one hour. The tube was then taken out of the oil bath and the fluid was poured in a cylindrical mould and allowed to solidify at room temperature.

Further modified sulphurs comprising with 1.0, 2.5, 5.0 and 7.5 wt % of 5-ethylidene-2-norbornene, respectively (samples 3 to 6; all according to the invention), were prepared by mixing sample 2 with further elemental sulphur at a temperature of 130° C. Each mixture was stirred at this temperature for 5 minutes and then poured in a cylindrical mould and allowed to solidify at room temperature.

A further modified sulphur (sample 7; not according to the invention) was prepared by weighting elemental sulphur and 10 wt % (based on the weight of sulphur) of a commercially-available sulphur modifier STX™ (ex. STARcrete Technologies Inc.) in a tube that was placed in an oil bath that was heated to 150° C. The mixture was stirred for 10 minutes. The tube was then taken out of the oil bath and the fluid was poured in a cylindrical mould and allowed to solidify at room temperature.

A sample of unmodified sulphur (sample 8; not according to the invention) was prepared by melting elemental sulphur by placing a tube with elemental sulphur for 10 minutes in an oil bath that was heated to 150° C. under stirring. The molten sulphur was then poured in a cylindrical mould and the sulphur was allowed to solidify at room temperature.

Alkaline Resistance

The alkaline resistance of the modified sulphurs prepared as described above was determined by placing the cylinders in a solution of 5M NaOH in water. The weight loss (wt % based on the initial weight of the sample) of the cylinders was measured after 15 and after 20 days in the 5M NaOH solution. The results are shown in Table 1.

TABLE 1
Weight Loss of Modified Sulphur Upon Immersion in 5 M NaOH

| | | | weight | weight | weight |
|---|---|---|---|---|---|
| | | | loss after | loss after | loss after |
| | | | 15 days | 20 days | 30 days |
| Sample | Modifier | | (wt %) | (wt %) | (wt %) |
| 1 | 5.0 | wt % ENB^{a} | 2.2 | 2.7 | |
| 2 | 10.0 | wt % ENB^{a} | | | <1 |
| 3 | 1.0 | wt %^{b} ENB^{a} | | | <1 |
| 4 | 2.5 | wt %^{b} ENB^{a} | | | <1 |
| 5 | 5.0 | wt %^{b} ENB^{a} | | | <1 |
| 6 | 7.0 | wt %^{b} ENB^{a} | | | <1 |
| 7 | 10.0 | wt % STX ™ | 34 | 57 | |

| | | | | |
|---|---|---|---|---|
| 8 | None | 20 | 80 | 100 |

^{a}ENB: 5-ethylidene-2-norbornene
^{b}prepared from 10 wt % ENB sample (sample 2)

### Example 2

The alkaline resistance of mortars prepared with unmodified sulphur and modified sulphur was determined.

Sulphur Mortar Preparation

Mortars comprising 50 wt % dried sand (Normsand), 30 wt % dried filler (quartz) and 20 wt % modified or unmodified sulphur were prepared by mixing the ingredients at 150° C. until an homogeneous mixture was obtained. The mixture was then poured in a steel mould that was pre-heated to 150° C. Pressure was applied (0.25-0.5 tons) until droplets of sulphur were visible at the bottom of the mould. The thus-formed mortar cylinders were then demoulded.

Three different mortars, each with a different sulphur were prepared:

Mortar 1—unmodified elemental sulphur (not according to the invention). Dried sand (50 wt %), dried quartz (30 wt %) and elemental sulphur (20 wt %) were mixed.

Mortar 2—sulphur modified with 11 wt % STX™ (not according to the invention). Dried sand (50 wt %), dried quartz (30 wt %), elemental sulphur (18 wt %) and STX™ modifier (2 wt %) were mixed.

Mortar 3—sulphur modified with 2.5 wt % 5-ethylidene-2-norbornene (according to the invention). Dried sand (50 wt %), dried quartz (30 wt %), elemental sulphur (15 wt %) and 5 wt % of a modified sulphur prepared with 10 wt % 5-ethylidene-2-norbornene were mixed. The modified sulphur prepared with 10 wt % 5-ethylidene-2-norbornene was prepared as sample 2 in EXAMPLE 1.

Alkaline Resistance

The mortars were immersed in a 5M NaOH solution during 30 days. After 30 days, mortar 1 was significantly more degraded than mortar 2 and mortar 2 was significantly more degraded than mortar 3.

The compression strength of the mortar cylinders was determined using a strain-controlled Zwick Z100 tensile machine with a 100 kN load cell. In Table 2, the compression strength of the three different mortars is given, both before and after immersion in 5M NaOH.

TABLE 2
Compression strength of sulphur mortars
after immersion in 5 M NaOH

| | | Compression Strength | |
|---|---|---|---|
| | | (MPa) | |
| | | | after 30 days |
| Mortar | Sulphur | initial | in 5 M NaOH |
| 1 | Unmodified | 60 | 7 |
| 2 | modified with 11 wt % STX ™ | 58 | 34 |
| 3 | modified with 2.5 wt % ENB | 69 | 51 |

### Example 3

The stability of three different modified sulphurs to allotropic transformation was compared by means of Wide Angle X-ray Spectroscopy (WAXS). The modified sulphurs were prepared by heating elemental sulphur and modifier in an amount of 5 wt % of the weight of sulphur at 140° C. for one hour. The mixture was then poured into an aluminium mould and allowed to solidify at room temperature. From 30 minutes after pouring the mixture in the mould, the crystal structure of the resulting sample (1.5×1×1 cm) was analysed by WAXS during 650 hours. The following amounts of modifier were added to the sulphur:

Sulphur sample 10: 5.0 wt % 5-ethylidene-2-norbornene (according to the invention).

Sulphur sample 11: 5.0 wt % STX™ (not according to the invention).

Sulphur sample 12: 5.0 wt % Chempruf modifier (not according to the invention). Sample 12 was prepared by heating sulphur and a commercially-availably modifier concentrate (Chempruf CONCENTRATE; ex. GRC Inc., Clarksville, Tenn.) in such amount that the modifier concentration was 5 wt % of the total sulphur weight. Chempruf CONCENTRATE comprises 25 wt % modifier and 75 wt % sulphur.

The X-ray diffraction measurements showed that the sulphur in sample 10 has stable monoclinic crystals. Even after 650 hours, the monoclinic crystals (beta crystallinity) were not reverted to the orthorhombic form (alpha crystallinity). In samples 11 and 12, crystal reversion from monoclinic to orthorhombic crystals was observed.

### Example 4

Binder-aggregate adhesion of mortars 1, 2 and 3 (see EXAMPLE 2) was determined by Environmental Scanning Electron Microscopy (ESEM) using a Philips XL30 FEG-ESEM in high vacuum mode. For the ESEM analysis, the mortars were manually broken until pieces of approximately 1×1×1 cm were obtained. The fraction surface to be examined was coated with a carbon layer.

ESEM analysis showed that in mortar 1 (unmodified sulphur as binder), the adhesion between sand and sulphur was poorer than in the two mortars using modified sulphur as binder. The ESEM analysis also showed that the unmodified sulphur in mortar 1 is more brittle than the modified sulphurs in mortars 2 and 3. In mortar 1, there were clear cracks in the sulphur phase itself. The sulphur modified with 2.5 wt % 5-ethylidene-2-norbornene (in mortar 3) appeared less brittle (virtually no cracks in the sulphur phase itself) than the STX™-modified sulphur in mortar 2 (some cracks in the sulphur phase itself).

What is claimed is:

1. Modified sulphur prepared by admixing molten elemental sulphur with one or more olefinic sulphur modifiers, wherein at least 50 wt % of the olefinic sulphur modifiers is 5-ethylidene-2-norbornene and/or 5-vinyl-2-norbornene and wherein the total amount of olefinic sulphur modifiers is in the range of from 0.1 to 20 wt % based on the weight of sulphur.

2. Modified sulphur according to claim 1, wherein at least 80 wt % of the olefinic sulphur modifiers is 5-ethylidene-2-norbornene and/or 5-vinyl-2-norbornene.

3. Modified sulphur according to claim 1, wherein no olefinic sulphur modifiers other than 5-ethylidene-2-norbornene or 5-vinyl-2-norbornene are admixed with the elemental sulphur.

4. Modified sulphur according to claim 3, wherein no olefinic sulphur modifier other than 5-ethylidene-2-norbornene is admixed with the elemental sulphur.

5. Modified sulphur according to claim 1, wherein the total amount of olefinic sulphur modifiers is in the range of from 5 to 15 wt % based on the weight of sulphur.

6. Modified sulphur according to claim 1, wherein the total amount of olefinic sulphur modifiers is in the range of from 7 to 12 wt % based on the weight of sulphur.

7. A product comprising modified sulphur as binder which is prepared by admixing a modified sulphur according to claim 1, a filler and/or aggregate, and optionally elemental sulphur at a temperature above the melting temperature of sulphur and solidifying the mixture obtained by cooling the mixture to a temperature below the melting temperature of sulphur.

8. A product according to claim 7, wherein the amount of olefinic sulphur modifier admixed in the preparation of the modified sulphur is at most 5 wt % of the total weight of sulphur in the product.

9. A product according to claim 7, wherein the product is sulphur cement or a sulphur cement-aggregate composite.

10. A product according to claim 7, which is prepared by admixing the modified sulphur, elemental sulphur, and a filler and/or aggregate.

11. A product according to claim 7, which is prepared by admixing the modified sulphur and a filler and/or aggregate.

12. A product according to claim 8, wherein the amount of olefinic sulphur modifier admixed in the preparation of the modified sulphur is in the range of from 0.1 to 4.0 wt % of the total weight of sulphur in the product.

13. A product according to claim 7, wherein the amount of olefinic sulphur modifier other than 5-ethylidene-2-norbornene or 5-vinyl-2-norbornene is at most 1 wt % of the total weight of sulphur in the product.

14. Modified sulphur according to claim 2, wherein no olefinic sulphur modifiers other than 5-ethylidene-2-norbornene or 5-vinyl-2-norbornene are admixed with the elemental sulphur.

15. Modified sulphur according to claim 2, wherein the total amount of olefinic sulphur modifiers is in the range of from 5 to 15 wt % based on the weight of sulphur.

16. Modified sulphur according to claim 3, wherein the total amount of olefinic sulphur modifiers is in the range of from 5 to 15 wt % based on the weight of sulphur.

17. Modified sulphur according to claim 4, wherein the total amount of olefinic sulphur modifiers is in the range of from 5 to 15 wt % based on the weight of sulphur.

18. Modified sulphur according to claim 2, wherein the total amount of olefinic sulphur modifiers is in the range of from 7 to 12 wt % based on the weight of sulphur.

19. Modified sulphur according to claim 1, wherein the total amount of olefinic sulphur modifiers is in the range of from 0.1 to 5 wt % based on the weight of sulphur.

20. Modified sulphur according to claim 2, wherein the total amount of olefinic sulphur modifiers is in the range of from 0.1 to 5 wt % based on the weight of sulphur.
